(19) United States
(12) Patent Application Publication
(10) Pub. No.: US 2018/0343174 A1
(43) Pub. Date: Nov. 29, 2018

(54) RULE BASED PAGE PROCESSING AND NETWORK REQUEST PROCESSING IN BROWSERS

(71) Applicant: Google Inc., Mountain View, CA (US)

(72) Inventors: Dominic Battre, Muenchen (DE); Aaron S. Boodman, San Francisco, CA (US); Matthew Perry, San Francisco, CA (US)

(73) Assignee: Google Inc., Mountain View, CA (US)

(21) Appl. No.: 13/647,541

(22) Filed: Oct. 9, 2012

(51) Int. Cl. H04L 12/24

(52) U.S. Cl. CPC H04L 41/50

(57) ABSTRACT

A web browser extension specifies a set of rules identifying types of network requests or attributes of document object models that the web browser extension seeks to modify. Each of the set of rules is expressed in a declarative expression. A web browser receives the set of rules from the web browser extension, evaluates conditions from the set of rules in native code of the web browser, and executes at least one action from the set of rules based on at least one fulfilled condition of the conditions, in native code of the web browser, to apply the at least one action to a network request or to a document object model related to a web page rendered by a renderer process of the web browser.

### TECHNICAL FIELD

This disclosure generally relates to rule based processing in the context of Internet browsers.

### BACKGROUND

Web browsers enable users to interact with and experience many different types of content, usually over a computer network, and often in a visual or graphical manner. For example, users may install one or more Internet browsers on a local computing device, and may thereafter utilize the Internet browser to access content and/or functionality provided by a remote computing device.

Many browser applications provide a user with an ability to customize or personalize an appearance or functionality of the browser application in a manner desired by the user. In particular, many browser applications support the use of discrete programs or files which are designed to provide a specific addition and/or alteration of one or more functionalities of an associated browser application. Such programs may be referred to using various, terminologies, such as, for example, extensions, browser extensions, add-ons, plug-ins, web apps, or just apps.

As referenced above, such programs generally operate to provide some additional, specific functionality for a user's local browser application. For example, browser extensions may modify network requests (in ways such as cancel requests, redirect requests, modify request headers, or contribute authentication information) or cause an icon, image, or other content to be available within the context of the browser application, which would not normally be available to the user in that context. The icon can be used, for example, to trigger actions in the browser. In such examples, such programs merely supplement already-present features and functionalities of the browser application.

In some cases, however, certain programs may utilize a content script or other executable code which is designed to interact with content that is being remotely accessed by the browser application for loading and rendering. For example, in a case where the browser application accesses a remote webpage over the Internet, such content script or other executable code associated with a program (such as a browser extension) may be configured to interact with (e.g., read or make changes to) the webpage itself content scripts are JavaScript files that run in the context of web pages. By using a standard Document Object Model (DOM), content scripts can read details of a webpage that a web browser visits, or make changes to webpages.

This set up provides good safety features to prevent websites and extensions to escape from the renderer sandbox to access resources of the host computer executing the browser. It has a certain set of disadvantages, however, such as resource consumption, excessive privileges including access to possibly confidential webpage content, and delays in runtime and start up performance.

For example, some of the most popular features of browser extensions are that extensions can block requests (e.g., blocking ads or plug-ins). Some browser extensions can also redirect or modify network requests, such that every time the web browser tries to go to URL “x” it is directed to URL “y” instead. Sometimes the rules to block, redirect, or modify requests are straightforward for a browser to apply. Yet, sometimes the rules are more complex. The more complex extension rules may slow down the web browser because they are usually written in JavaScript, which means that the web browser, for every single web request, must send a call into the extension's JavaScript, asking what to do with a URL. Then the browser extension provides an answer. Sometimes, the whole browser stack may be hung up waiting for one or more browser extensions to respond to a request. The delay may worsen when many tabs of the web browser are open and going to different websites, in which case the web browser may be sending a number of requests in parallel. If there is one browser extension that has to answer for every single request, this one extension may become a bottleneck for all tabs.

### SUMMARY

According to one general aspect, a system includes a processor configured to execute a web browser in a first browser execution process initiated by an operating system of the system, and to execute a web browser extension installed in the web browser. The web browser extension may be configured to specify a set of rules identifying types of network requests or document object models that the web browser extension seeks to modify, each of the set of rules expressed in a declarative expression. The web browser may be configured to: receive the set of rules from the web browser extension, evaluate conditions from the set of rules in native code of the web browser, and execute at least one action from the set of rules based on at least one fulfilled condition of the conditions, in native code of the web browser to apply the at least one action to a network request or to a document object model related to a web page rendered by a renderer process of the web browser.

According to another general aspect, a method for executing browser extensions in a web browser application may include executing, using a processor of a computing device, the web browser application including a rules engine that manages a declarative set of rules registered by browser extensions. The method may include notifying, using an event generator of the web browser application, the rules engine of an event. The method may include sending, by the rules engine, a description of at least one action to an action executor of the web browser application, the at least one action including a command to redirect a network request to a new destination. The method may also include verifying, by the action executor, a permission to perform the command. The method may also include redirecting the network request to the new destination.

According to yet another general aspect, a computer program product may be embodied on a non-transitory computer-readable medium and may include executable code that, when executed, is configured to cause a computing device to: receive a set of declarative rules from a web browser extension; execute the set of declarative rules in native code of a web browser; monitor conditions from the set of declarative rules until a condition is met; and trigger at least one action when the condition is met to apply the set of declarative rules to a network request or to a document object model of a web page rendered by a renderer process of the web browser.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating an example of a web browser with a multi-process architecture, in accordance with systems and methods described here.

FIG. 2 illustrates an example rule that may be utilized for rule based page processing in accordance with systems and methods described here.

FIG. 3 is a block diagram of a system that may implement rule based paged processing in accordance with systems and methods described here.

FIG. 4 is a flow diagram of an example process to implement rule based page processing in accordance with systems described here.

FIG. 5 is a block diagram showing example or representative computing devices and associated elements that may be used to implement the systems and methods of FIGS. 1-4.

### DETAILED DESCRIPTION

A “browser extension” or “extension” as referred to herein may include a manifest file that gives information about the extension, (such as the most important files, or capabilities and permissions) and at least one HTML file, and may also include JavaScript files, image files, or other files. Extensions may be bundled in a zipped format.

Extensions may specify and provide to an application, such as a web browser, a set of rules or patterns. The set of rules may be provided prior to execution, for example through a JavaScript interface. For example, a browser extension can specify to block or redirect a certain pattern of URLs. The web browser may, in some implementations, receive rules expressed in a declarative way, such that their evaluation is optimized and so that they are executed in native code of the web browser, rather than in an interpreted language. The rules can be run in parallel on each tab, which reduces latency previously induced by the browser extension. The rules may execute in native code of the web browser so that the rules run as fast as if the logic was implemented in the web browser itself.

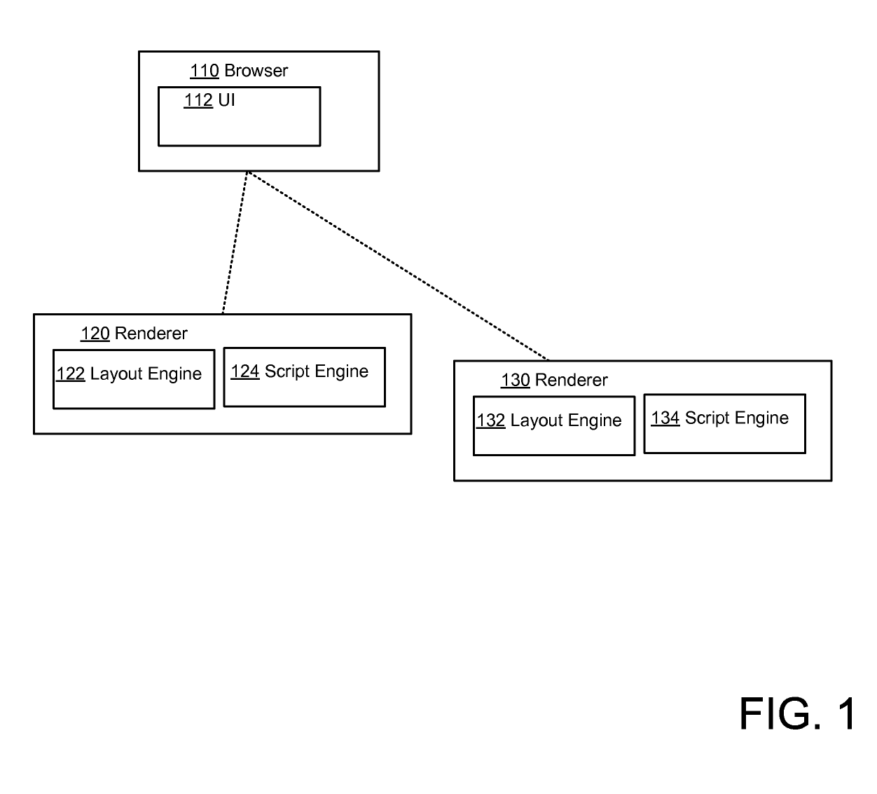

Certain web browsers may include a multi-process architecture for security reasons. FIG. 1 is a block diagram illustrating an example of a web browser with a multi-process architecture. As shown in FIG. 1, a browser 110 may represent a visible part of a web browser application. The browser 110 may provide a user interface (UI) 112 (including, for example, menus, window controls, tabs for multi-tabbed browsing) and may display web pages. Browser 110 may be responsible for fetching web resources such as HTML documents, images, JavaScript files, CSS style sheets, etc., on behalf of one or more “renderers.”

The browser 110 may be connected, for example via Inter Process Communication, to one or more renderers, shown in FIG. 1 as renderers 120 and 130. A renderer 120 or 130 may layout web pages from the Internet and may provide pixel or vector graphics for the browser 110 to display. Renderers 120 and 130 may each include a layout engine 122, 132, such as WebKit, which parses HTML documents into a Document Object Model (DOM). The layout engine 122, 132 may calculate a layout of content transforms or annotate the DOM in such a way that it can be displayed on a computer screen. The renderers 120, 130 may also contain one or more Script Engines 124, 134, such as V8. Script Engines 124 or 134 may interpret and execute script languages such as JavaScript, ECMAScript, or Dart. A renderer 120 may be executed in a sandboxed process with low privilege levels to prevent malicious code from exploiting security holes and attacking a host computer.

Browsers may offer an extension system which allows developers to extend the functionality of the browser. Extensions may be executed in a script language in renderer processes. Extensions may possess higher privilege levels than regular websites but may still be sandboxed in a renderer to prevent, for example, direct access to a network or to the hard drive of the host computer.

In some implementations, extensions may include a “background page” and content scripts. The background page is an HTML page with embedded JavaScript that runs persistently in the background. The background page may register event listener that react to events. Such event listeners may subscribe, for example, to network events and react by redirecting requests to different destinations. The background page has elevated privileges compared to the web page and may interact with the browser.

Content scripts may include scripts originating from extensions that are injected into web pages. Content scripts may allow modifying the DOM of their associated web pages and may communicate with the background page. Content scripts run at a low privilege level and may to communicate with the background page for certain actions such as fetching resources from the internet. This set up provides safety features to prevent websites and extensions from escaping from the renderer sandbox to access resources of the host computer executing the browser.

Yet, extensions may cause resources consumption. For example, in some implementations, each extension may have a background page which runs persistently in memory. This background page consists of a DOM and an instance of a runtime environment for the script engine (e.g., script engine 124). As the life-cycle of a background page starts at browser startup time, or when an extension is installed, the background page initializes configuration parameters and sets up event listeners at that time and needs to remain in memory from thereon. This means that the background page consumes resources (in particular memory), even if the extension does not do anything most of the time.

Further, because in some implementations an extension can access a web page's DOM and communicate with the Internet via the background page, the extension has a large attack surface that may be used to gather confidential user data, such as account names and passwords, and communicate these to web servers. The browser may make these privileges transparent to the user, but the user needs to trust the extension to not exploit its privileges. This may happen both intentionally or unintentionally due to programming errors. The risk may be rather high due to the expressiveness of the scripting language of extensions.

Additionally, message passing between extensions executed in a renderer and the browser may incur runtime penalties. As an example, there may be an extension that inspects and modifies network traffic, for example to redirect HTTP requests to use the HTTPS protocol for security reasons. The renderer of a website sends a request for a HTTP resource to the browser. The browser needs to send a message to the renderer hosting the extension to ask how to process this request. The extension determines whether the request shall be just executed or modified and returns the result to the browser, which executes the decision. This process is usually very fast because the communication between renderers and the browser is highly optimized. In case the message bus is busy, however, there may be long delays.

Further, if extensions need to intercept network traffic for security reasons, they may need to be loaded before any network communication may be executed by the browser. This would require the loading of a background page and starting a renderer including a script execution runtime environment. This incurs startup delays, which are considered a high cost for a web browser.

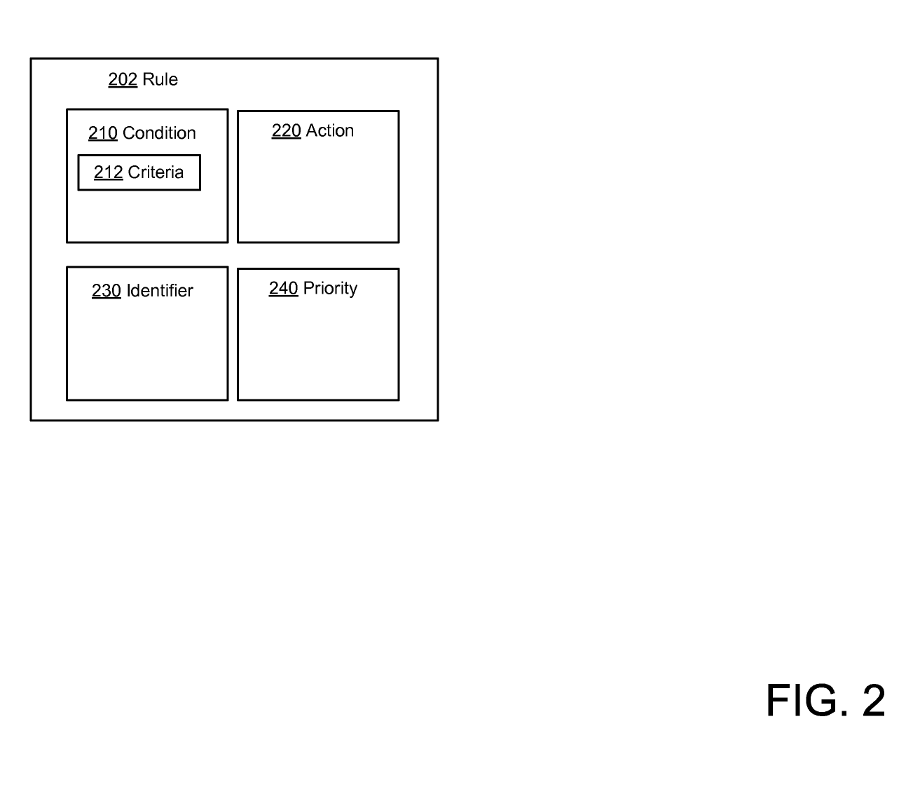

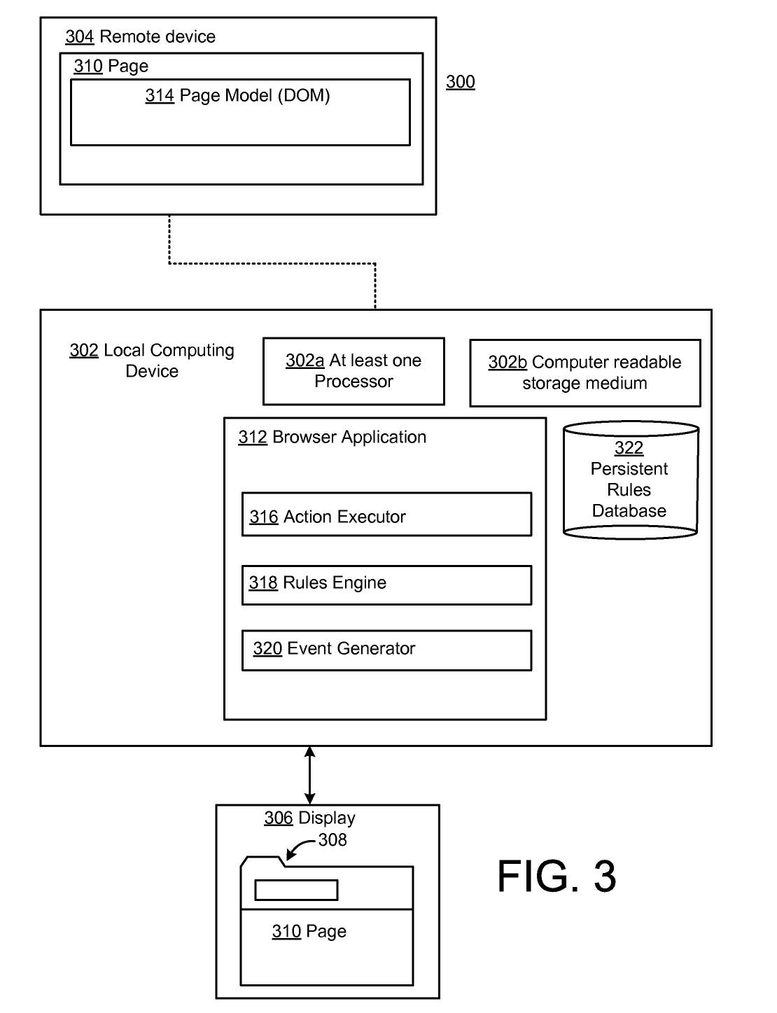

A declarative extension system mitigates the issues described above. Such a declarative extension system replaces the continuously executed background page with event listeners that listen and react to events such as user clicks, navigation events, and others, by a rules engine (which is described in more detail below with respect to FIG. 3.) The rules engine manages a set of rules. Each extension may register rules, and may also remove and query rules registered by the extension. The rules engine can register rules once and extensions do not need to continue executing the background page because rules are self-contained and do not require a JavaScript engine (such as Script engine 124) to be executed. To understand how to manage rules provided by extensions, examples are explained in more detail below with respect to FIG. 2.

FIG. 2 illustrates an example rule that may be utilized for rule based page processing in accordance with systems and methods described here. A rule 210 may include at least one condition 210 and at least one action 220. The example shown in FIG. 2 illustrates only one condition 210 and one action 220, for the purpose of illustration only.

Conditions are continuously monitored and trigger specified actions.

Condition 210 may include one or more criteria 212, which are described in more detail below.

Rule 202 may also, in some implementations, include an identifier 230 and a priority 240. The identifier 230 and priority 240 may be optional. In some implementations, identifier 230 and priority 240 may be automatically generated by the browser. Identifier 230 may be used, for example, to simplify removing or modifying previously registered rules.

Expressed another way, Rules=Condition⁺×Action⁺×Identifier×Priority.

In the context of network requests, a condition 210 may filter network requests based on various criteria 212. Criteria may include, as examples, a target URL, a top frame URL, request or response headers, cookies, tabs, etc. Actions may include, as example, cancelling requests, redirecting requests to static targets, redirecting requests based on Regular Expressions with substitutions, modifying request or response headers, modifying cookies, modifying the DOM elements associated with the network requests, etc.

In the context of user interfaces and website interaction, conditions may trigger actions based on criteria such as the existence of DOM nodes that fulfill CSS selectors or another query language, DOM events such as click or keyboard events, timer events, or other criteria. Actions may include modifying the DOM or CSS styles, showing UI elements, activating or triggering features of the extension (e.g. configuration dialogs, showing icons in the browser UI), calling JavaScript functions that are injected into the website, etc.

Each condition 210 may consist of one or more attributes that are considered. In an example of a network scenario, a condition 210 may filter network events based on a target URL and a main frame URL, which may be shown in a browser URL bar (not shown in FIG. 2). Such a filter may be expressed as, for example:

{
url: {hostSuffix: “foo.com”, pathPrefix: “/login.js”},

mainFrameUrl: {hostSuffix: “bar.com”}

}

In this example, the condition may be triggered if a JavaScript “login.js” is downloaded from a server with a host name that ends in “foo.com” in the context of a website that is shown to the user and hosted on a server with a host name ending in “bar.com”.

Conditions may be arbitrarily complex and may contain conjunctions and disjunctions of matching criteria. If any condition of a rule is fulfilled, the actions associated with the rule may be executed, as described in more detail below with respect to FIG. 3.

As shown in FIG. 2, each rule 202 may include a priority 240 (which is optional). Priority 240 may be used to determine the order in which rules, such as rule 210, are executed. A rule with a high priority may be executed before rules with lower priorities. A high priority rule may instruct a rule engine (which is described in more detail below with respect to FIG. 3) via an action to ignore all actions of rules of lower priority. This mechanism may be used as an exception mechanism. This is illustrated in the following example:

var ruleA = {

conditions: [ newRequestMatcher({url: {pathContains:

“evil.js”}}) ],

actions: [ new CancelRequest( ) ],
priority: 1

}
var ruleB = {

conditions: [ new RequestMatcher({url: {hostSuffix:

“testserver.com”}}) ],

actions: [ new IgnoreRulesOfLowerPriority( ) ],
priority: 1000

}

While the first ruleA would disable all access to URLs containing “evil.js”, the second ruleB would whitelist a server (“testserver.com”).

In some implementations, if two actions of an extension conflict, the action belonging to a rule of higher priority may take precedence. If the respective rules have identical priority, a tiebreaker such as registration time of the rule may be used.

While priorities of rules influence the relative importance of rules of a single extension, multiple extensions may trigger conflicting actions. Conflicts between actions of rules of different extensions may be resolved based on a precedence of extensions.

Because rules are expressed in a declarative way, their evaluation may be optimized and executed in native code, rather than an interpreted language.

The condition evaluation may be optimized for performance. If many conditions need to be evaluated on the URL of requests, this evaluation may happen in parallel by using string set matching algorithms, such as the Aho-Corasick algorithm, whose runtime does not depend on the number of strings (patterns) in the set that is matched against the URL. In some implementations, the criteria of many rules may be evaluated in parallel because the criteria are represented as a state machine. As an example, if looking for criteria “aaaaaaB” and “aaaaaaC”, the criteria may be rewritten to “aaaaaa” followed by “B” or “C”. Therefore, the system may not need to first search for the first pattern and then for the second pattern. In additional or alternative implementations, different threads or different processes may evaluate rules in parallel.

FIG. 3 is a block diagram of a system that may implement rule based paged processing in accordance with systems and methods described here.

In the example of FIG. 3, a local computing device 302 is illustrated as communicating with a remote computing device 304 in order to provide, using a display 306, a browser window 308 which contains a page 310 that is stored at the remote device 304. Remote device 304 may be a computing device such as a server, for example.

A local device 302 may generally represent virtually any computing device which may be configured to execute browser application 312, and to communicate with the remote device 304. For example, the local device 302 may include any standard desktop or personal computing device, any laptop, notebook, or netbook computer, any tablet computer, or any Smartphone or other mobile computing device. Such computing devices, and other computing devices, may be configured to access the remote device 304 over one or more computer networks. For example, many local devices 302 may include various types of network-related hardware/software which enable the local device 302 to communicate over the public Internet, private intranet, or other network, to thereby access the remote device 304. Consequently, the display 306 may be understood to represent virtually any type of display, e.g., monitor, touch-screen, or any other type of visual or auditory display.

In the examples that follow, it is generally assumed that the local device 302 and the browser application 312 communicate with the remote device 304 over the public Internet, therefore typically using protocols for identifying, accessing, and rendering the page 310, e.g., from a web server represented by the remote device 304. However, it will be appreciated that such examples are provided merely for the sake of clarity and conciseness, and, as just referenced above, are not intended to be limiting of the various manners in which the local device 302 may obtain, process, or provide content in association with the browser application 312 and the browser window 308.

Thus, in the types of examples just referenced, it may generally be assumed that the page 310 represents any of the many types of webpages which are available over the public Internet. For example, in a simple scenario, the page 310 may represent a substantially static page which includes text, sound, images, or other content which may be desired by a user of the system 300 and which may be displayed within the browser window 308. In other examples, the page 310 may include many types of dynamic or interactive content, which often may be manipulated by the user within the context of the browser window 308. In many scenarios, the page 310 and/or associated executable code may be understood to represent an application which may execute partially or completely at the remote device 304 (e.g., may utilize the processor, memory, and other hardware/software resources of the remote device 304), while providing associated functionality and features to the user via the browser window 308 (and perhaps executing at least partially locally at the local device 302). As just referenced, such webpages and associated functionalities and applications are implementable using various, programming languages and techniques, such as, for example, hypertext markup language (HTML), Asynchronous JavaScript (AJAX), eXtensible Markup Language (XML), JavaScript, JavaScript object notation (JSON), and many other types of code which may be executed.

In the example of FIG. 3, the page 310 at the remote device 304 is illustrated as including, or being associated with, a page model 314. Generally speaking, the page model 314 provides a data structure which defines the structure, content, and appearance of the page 310 with respect to a programming language in which the page 310 is written.

In specific examples described herein, the page model 314 may represent a document object model (DOM) data structure. Such a DOM, as just referenced, represents a data structure (typically, a tree-like data structure) that itself represents HTML of the page 310.

As described herein, browser extensions may be utilized in the system 300 to provide additional features or functionalities in association with the browser application 312, and thus with respect to the browser window 308. The functionality of extensions may include but are not limited to observing and modifying network traffic and modifying the page model 314 of the page 310. Other functionality may include interacting with the user, and adding buttons and other user interface elements to the browser and handling their interaction with the user.

As may be understood from the above description, extensions defined by the extension files 322 may generally refer to browser extensions, add-ons, or any other program code which is designed to augment an appearance or functionality of the browser application 312 in providing the browser window 308 and/or the example page 310. Extension files 322 may in particular perform modifications to network requests related to web page 310, such as canceling requests for individual resources, redirecting the request for web page 310 or referenced resources, modifying request and response headers of web requests related to web page 310, or contributing authentication information to retrieve web page 310. For example, an extension may redirect a user who has requested a link of www.badlink.com to www.goodlink.com.

The browser application 312 may include an event generator 314, an action executor 316, and a rules engine 318. Rule engine 318 may be instantiated in the browser or in a renderer process. Each rule type scenario (for network events, UI events, etc.) may be implemented by a domain specific rules engine 318. In some implementations, rules engine 318 may compile rules provided by browser extensions into a program (e.g., a state machine) that it may execute for each URL (or more generally, each network request). When the user navigates to each URL, the rules engine 318 may apply the state machine to each URL.

For example, the rules engine 318 may be notified of events by the event generator 314. The event generator 314 may, in some implementations, be the network stack which is about to send a new resource request to the network or the DOM representation which notices a change in the DOM 314. The rules engine 318 may execute actions triggered by rules itself, or may pass descriptions of these actions to the action executor 316. For example, in the network scenario, the rules engine 318 may pass the command to redirect a network request to a new destination to the action executor 316, which then verifies that the extension had the permission to perform such a redirect.

In some implementations, rules may be persisted to a disk or database, such as persistent rules database 322 shown in FIG. 3, which may be any type of data store associated with local computing device 302. In such implementations, the rules can be loaded (e.g., by rules engine 318) efficiently when the browser application 312 starts up. Thus, no script engine execution environment (e.g., a JavaScript engine) needs to be loaded for rule execution. This allows for blocking all network requests until the rules are loaded (e.g., from persistent rules database 322).

Of course, it may be appreciated that the browser application 312 may include, or be associated with, various features, functions, operational modules, or other elements which are not specifically illustrated in the context of FIG. 3. Similarly, it may be appreciated that the terminology used in association with the event generator 314, action executor 316, rules engine 318, and persistent rules database 322 is merely for the sake of example, and that the various types of browser applications 312 which exist, or which may exist in the future, may use different terminology when referring to the various concepts described herein.

Because the expressiveness of declarative rules and the possibility to interact with the DOM 314 or generate network requests to web servers is significantly lower than that of an event listener model using background pages, declarative rules may, in various implementations, be associated with lower permissions requested from the user. In various implementations, permissions are not tied to conditions but actions. Uncritical actions, such as cancelling a request or showing an icon, may not require any user permissions at all.

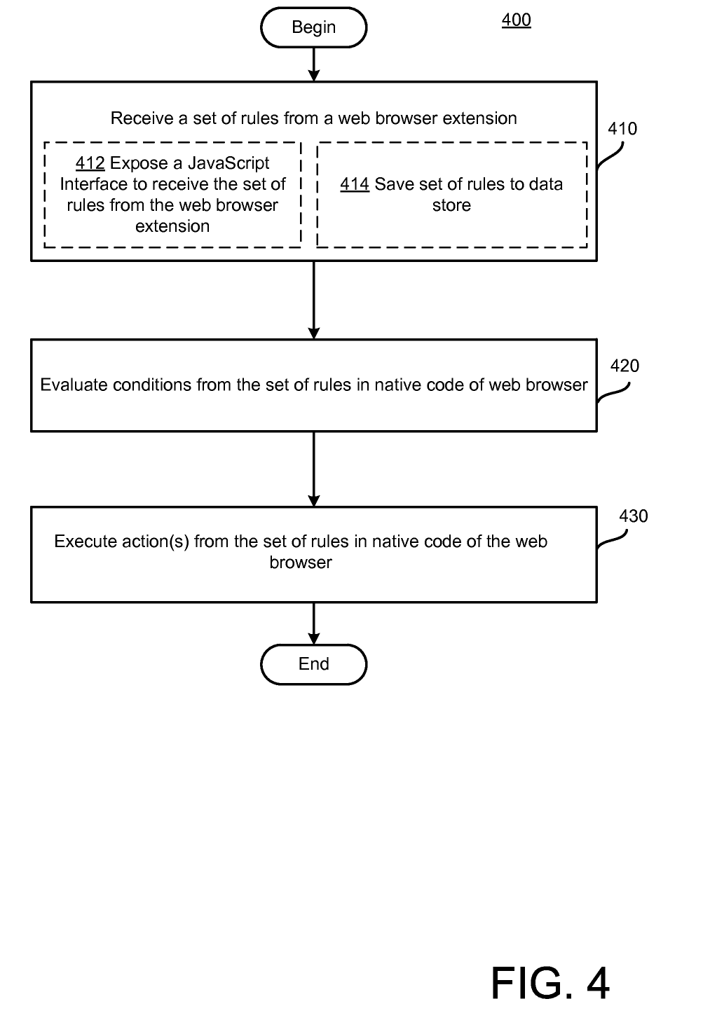

FIG. 4 is a flow diagram of an example process to implement rule-based page processing in accordance with systems described here. The process described with respect to FIG. 4 may be implemented by a browser application, such as browser application 312 shown in FIG. 3. The browser application may receive a set of rules from a web browser extension (410). The set of rules may identify types of network requests or document object models that the web browser extension seeks to modify. The set of rules may be expressed in a declarative expression, meaning that the rules may consist of declarative conditions and actions. Conditions are evaluated in the browser, rather than a JavaScript engine, which may reduce roundtrip latencies and allow for high efficiency, as mentioned above.

The browser application may, in some implementations, expose a JavaScript interface to receive the set of rules from the web browser extension (412). In some implementations, a browser extension may call a function to add rules, or to remove rules, for example using rule identifiers discussed above with respect to FIG. 2.

The web browser extension may, in some implementations, be programmed in a type of code (e.g., JavaScript) other than the native code of the web browser. The set of rules may be saved (e.g., automatically by the web browser) to a data store (e.g., a local disk of a computing device that is executing the web browser) (414). The set of rules may be loaded from the data store, for example at a browser start time (not shown in FIG. 4).

In some implementations, a developer may declare a permission (e.g., a “declarative” permission) in a manifest file of the browser extension, along with host permissions for any hosts whose network requests the browser extension wants to access.

The browser application may evaluate conditions from the set of rules in native code of the web browser (420). The browser application may then execute actions from the set of rules, in native code of the web browser (430), for example to apply an action to a network request or a document object model related to a first web page rendered by a renderer process of the browser application. In some implementations, the browser application may apply the action to the network request based on at least one criterion of a condition from the set of rules. The criteria may include, for example, pattern matches on the URL being requested, on the top frame URL, the existence of request or response headers, cookies, etc.

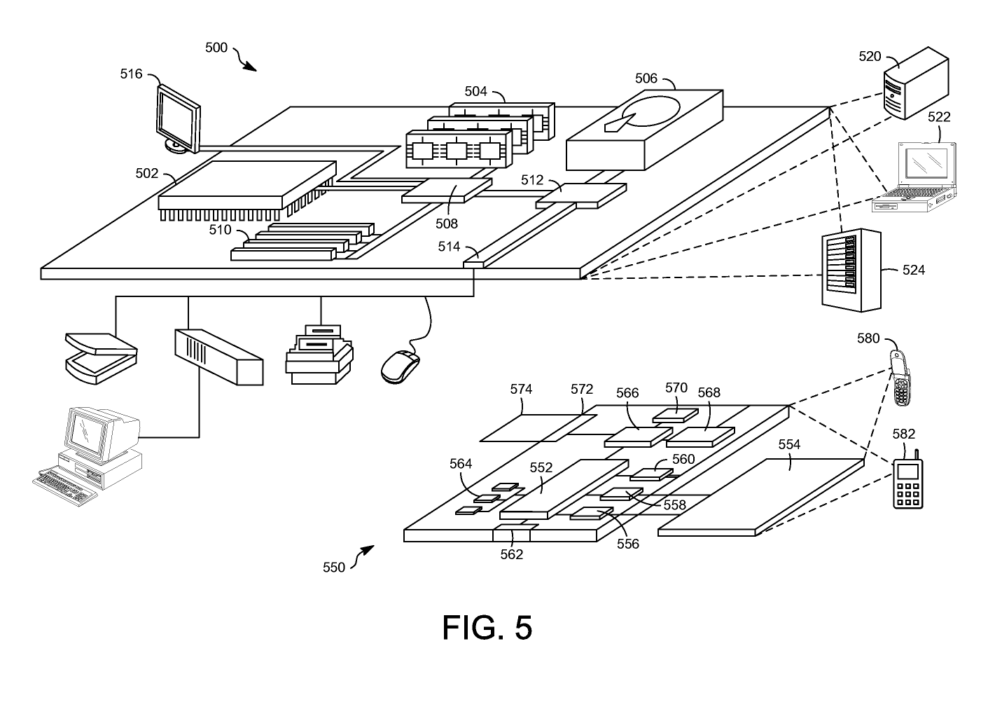

FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart phones, and other similar computing devices. The components shown here, their connections and relationships, and their functions, are meant to be exemplary only, and are not meant to limit implementations described in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 530, or multiple times in a group of such servers. It may also be implemented as part of a rack server system 524. In addition, it may be implemented in a personal computer such as a laptop computer 532. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may include appropriate circuitry for driving the display 554 to present graphical and other information to a user. The control interface 558 may receive commands from a user and convert them for submission to the processor 552. In addition, an external interface 562 may be provided in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provided as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDM33000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning system) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smart phone 582, personal digital assistant, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above implementations that have been described in particular detail are merely example or possible implementations, and that there are many other combinations, additions, or alternatives that may be included.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

1. A system comprising:
at least one processor configured to execute, in memory, a web browser in a first browser execution process initiated by an operating system of the system, and to execute a web browser extension installed in the web browser;
the web browser extension configured to specify a set of rules identifying types of network requests that the web browser extension seeks to modify, each of the set of rules including conditions and actions that are expressed in a declarative expression; and
the web browser configured to:
receive the set of rules from the web browser extension,
evaluate, in the web browser, the conditions from the set of rules, the evaluation being triggered based on determining that a received network request includes a target URL downloaded from a server having a host name that includes a top frame URL determined to match criteria in at least one of the conditions, the evaluating of the conditions being performed to replace continuous execution of a background page associated with the browser, and
execute at least one action from the set of rules based on at least one fulfilled condition of the conditions, to apply the at least one action to the received network request related to a web page rendered by a renderer process of the web browser, the executing of the at least one action including filtering the network request based on the top frame URL and a request header associated with the web page.

2. The system of claim 1, wherein the conditions are evaluated in native code of the web browser and the at least one action is executed in native code of the web browser.

3. The system of claim 1, wherein the web browser is further configured to expose a JavaScript interface to receive the set of rules from the web browser extension.

4. The system of claim 1, wherein the web browser is further configured to block all network requests until the set of rules are loaded.

5. The system of claim 4, wherein the set of rules are loaded at a browser startup time.

6. The system of claim 1, wherein applying the at least one action includes analyzing the network request using at least one criterion of the conditions associated with the set of rules.

7. The system of claim 1, wherein applying the at least one action includes triggering the at least one action based on the at least one condition, the at least one action including redirecting the network request.

8. The system of claim 1, wherein applying the at least one action includes modifying the network request.

9. The system of claim 1, wherein the web browser is further configured to monitor the condition from the set of rules that triggers the at least one action based on the condition, the action, and the at least one criterion being provided by the set of rules.

10. The system of claim 9, wherein the at least one criterion includes matching patterns associated with a request header, a response header, a cookie, or a tab, and wherein the at least one action includes cancelling the network request based on a respective matched pattern associated with the request header, the response header, the cookie, or the tab.

11. The system of claim 9, wherein the at least one criterion includes document object model events.

12. (canceled)

13. The system of claim 1, wherein the web browser is further configured to simultaneously apply the set of rules in parallel to a second received network request related to a second web page.

14. The system of claim 13, wherein the second web page operates in a second renderer process separate from the renderer process.

15. The system of claim 1, wherein the web browser extension is programmed in a type of code other than native code associated with the web browser.

16. (canceled)

17. The system of claim 1, wherein the browser is further configured to allow the web browser extension to remove the set of rules.

18. The system of claim 1, wherein the web browser is further configured to determine an order in which to execute the set of rules based on priorities established by the set of rules.

19. A method for executing browser extensions in a web browser application comprising:
executing, using a processor of a computing device, the web browser application including a rules engine that manages a declarative set of rules registered by browser extensions, the declarative set of rules being compiled, by the rules engine, into an executable state machine;
notifying, using an event generator of the web browser application, the rules engine of an event;
sending, by the rules engine, a description of at least one action to an action executor of the web browser application, the at least one action including a command to redirect a received network request to a new destination;
verifying, by the action executor, a permission to perform the command, the verification including evaluating, in a plurality of tabs in the web browser, conditions from the set of rules, the evaluation being triggered based on determining that the received network request includes a target URL downloaded from a server having a host name that includes a top frame URL determined to match criteria in at least one of the conditions, the evaluating of the conditions being performed to replace continuous execution of a background page associated with the browser; and
redirecting the network request to the new destination in response to determining that the conditions are met.

20. A computer program product, the computer program product being embodied on a non-transitory computer-readable medium and including executable code that, when executed, is configured to cause a computing device to:
receive a set of declarative rules from a web browser extension;
execute the set of declarative rules in native code of a web browser;
monitor, by the web browser and in parallel for a plurality of tabs of the web browser, conditions from the set of declarative rules received from the web browser extension, until a condition is met, the monitoring including evaluation of the conditions triggered based on determining that a received network request includes a target URL downloaded from a server having a host name that includes a top frame URL determined to match criteria in at least on of the conditions, the evaluation being performed to replace continuous execution of a background page; and
trigger at least one action when the condition is met to apply the set of declarative rules to the received network request, the action including filtering the network request based on the top frame URL.

21. The computer program product of claim 20, wherein each rule includes at least one condition, at least one action, at least one identifier, and a priority.

22. The method of claim 19, wherein the notifying includes notifying the rules engine of an event associated with at least one uniform resource locator accessed in the web browser and the at least one action includes a command to execute the state machine on the at least one uniform resource locator to determine whether to redirect the network request to the new destination.
